(19) United States
(12) Patent Application Publication
(10) Pub. No.: US 2025/0042117 A1
(43) Pub. Date: Feb. 6, 2025

(54) METHOD FOR OPERATING A PUNCHING PRESS

(71) Applicant: BRUDERER AG, Frasnacht (CH)

(72) Inventors: Manuel BÜHLER, Arbon (CH); Christian KREIS, Egnach (CH)

(21) Appl. No.: 18/716,988

(22) PCT Filed: Dec. 8, 2021
(86) PCT No.: PCT/EP2021/084780

§ 371 Date: Jun. 6, 2024

(51) Int. Cl. B30B 15/14; B21D 43/02; B30B 1/26; B30B 15/30

(52) U.S. Cl. CPC B30B 15/146; B21D 43/025; B30B 1/26; B30B 15/30

(57) ABSTRACT

A method for operating a punching press with a press plunger driven by a crank drive, which operates in a machining zone of the punching press against a stationary clamping plate, and with a servo feed apparatus for intermittently feeding a band of material to be processed to the machining zone. In punching mode, the press plunger is moved back and forth by the crank drive between a first movement dead point (0°), in which the press plunger is at maximum distance from the clamping plate, and a second movement dead point (180°), in which the press plunger is at minimum distance from the clamping plate. In the process, the material band is pushed by the servo feed apparatus around the first movement dead point (0°) in a first rotation angle window (3) of the crank drive by a certain length into the machining zone and processed in a second rotation angle window during the feed pauses. The feed movement of the servo feed drive takes place according to an electronically defined feed movement profile (5), which is followed in the first rotation angle window (3) in an electronically synchronized manner to the rotation of the crank drive (4). When a press stop (6) is triggered in the first rotation angle window (3), the synchronization of the feed movement profile (5) with the rotation of the crank drive (4) is canceled and the feed movement profile (5) is moved to the end independently of the rotation of the crank drive (4). This mode of operation reduces the maximum torque requirement of the feed axes for servo feeds operated angularly synchronously with the crank drive of the press plunger, so that smaller and therefore more cost-effective servo drives can be used or more load can be moved with a given servo drive.

### CROSS-REFERENCE TO RELATED APPLICATION

This application is a National Stage application of International Patent Application No. PCT/EP2021/084780, filed on Dec. 8, 2021, which is hereby incorporated by reference in its entirety.

### TECHNICAL FIELD

The present invention relates to methods for operating a punch press and to a punch press for operation according to the methods according to the preambles of the independent claims.

### BACKGROUND

Servo feeds for feeding the material band to be processed are increasingly being used in modern punching presses, on which products are punched from a material band using the progressive cutting process. These can be controlled flexibly, in contrast to mechanical feeds, which are forcibly mechanically coupled to the crank drive of the press plunger. With the servo feeds, the band material is either fed by an entire predetermined feed length in response to a feed signal (cam-triggered) or, similar to the operation of the mechanical feeds, in accordance with an electronically defined feed profile synchronized at an angle with the crank drive of the press plunger. The latter operating mode has the great advantage over the cam-triggered variant that the feed step is extended at all times in relation to the press plunger and the achievement of the target position can be monitored at every point (support point) of the electronically defined feed profile and corrected if necessary. This results in an overall higher level of safety in the process, as can be seen from the following two examples:

Example 1: Feed phase 300° to 60°, i.e. symmetrical around top dead point (0°), feed length 20 mm. Feed control in the tool at 0°, i.e. half the feed length (10 mm). Due to the angular synchronization, an immediate stop of the press can be initiated when the feed control is triggered. With a cam-triggered feed, the feed length can only be monitored at the end of the step because there is no positive guidance. The feed control can therefore only trigger an immediate stop at the end of the feed. This results in a longer braking angle of the press by half the feed phase compared to the angle-synchronized feed.

Example 2: Triggering of an immediate stop, e.g. due to press overload (process error). The press comes to a standstill just within the feed phase due to the braking angle. With force-guided feed, only a small amount of band material is fed forward, whereas with cam-triggered feed, an entire feed length of band material is pressed into the tool, which increases the risk of tool damage.

However, a disadvantage of the servo feeds known today, in which the band material is fed at a synchronized angle with the crank drive of the press plunger, is that they require relatively powerful servo drives because, depending on the starting conditions, large accelerations and thus large torques must be provided on the feed axes, which is associated with corresponding investment costs and can lead to restrictions with regard to the band material to be conveyed.

### SUMMARY

The objective is therefore to provide technical solutions that retain the advantages of angle-synchronous operation with servo feeds, but do not have the disadvantages described above or at least partially avoid them.

This objective is reached by the subject matter of the independent patent claims.

According to these, a first aspect of the invention relates to a first method for operating a punching press with a press plunger driven by a crank or eccentric drive with a first part of a machining tool, wherein the press plunger operates in a machining zone of the punching press against a stationary clamping plate with an associated second part of the machining tool, and with a servo feed apparatus for intermittently feeding a band of material to be processed to the machining zone of the punching press.

In this first method according to the invention, the press plunger is moved back and forth by the crank or eccentric drive between a first movement dead point, in which the press plunger is at a maximum distance from the clamping plate and the machining tool is at a maximum open position, and a second movement dead point, in which the press plunger is at a minimum distance from the clamping plate and the machining tool is at a maximum closed position, during the intended punching operation of the punching press. In typical punch presses, where the press plunger works from above against a fixed clamping plate, these movement dead points are the top dead point (also called “TDC”) and the bottom dead point (also called “BDC”) of the press plunger.

The material band is advanced into the machining zone by a certain length by the servo feed apparatus in a first rotation angle window of the crank or eccentric drive around the first movement dead point and is processed with the machining tool in the feed pauses in a second rotation angle window of the crank or eccentric drive, which extends outside the first rotation window before and up to the second movement dead point.

The feed movement of the servo feed apparatus takes place during the intended punching operation of the punching press according to an electronically defined feed movement profile, which is electronically synchronized with the rotation of the crank or eccentric drive in the first rotation angle window.

According to the invention, when a press stop is triggered in the first rotation angle window, the synchronization of the feed movement profile with the rotation of the crank or eccentric drive is cancelled and the feed movement profile is followed to the end independently of the rotation of the crank or eccentric drive.

This first operating method according to the invention reduces the maximum torque requirement of the feed axes for servo feeds operated angularly synchronously with the crank drive of the press plunger, so that smaller and therefore more cost-effective servo drives can be used or more load can be moved with a given servo drive.

Preferably, the feed movement profile is followed at a rotation speed that corresponds to the rotation speed at which it was followed at the time the press stop was triggered or at the time the synchronization of the feed movement profile with the rotation of the crank or eccentric drive was cancelled. This ensures that the feed step is completed before any further rotation of the crank or eccentric drive of the press can reach the second rotation angle window.

In the event that the rotation of the crank or eccentric drive after triggering the press stop does not come to a standstill at a certain rotation angle before a subsequent first rotation angle window or before entering a subsequent first rotation angle window, it is preferred according to a first variant that the feed movement profile is completely followed again after reaching the subsequent first rotation angle window.

It is preferable that the feed movement profile, after reaching the subsequent first rotation angle window, is again completely followed at a rotation speed that corresponds to the rotation speed at which it would be followed if synchronized with the rotation of the crank or eccentric drive when entering this subsequent first rotation angle window. This ensures that the feed step is completed before the rotation of the crank or eccentric drive of the press can reach the subsequent second rotation angle window.

According to a second variant, in the event that the rotation of the crank or eccentric drive does not come to a standstill at a specific rotation angle before a subsequent first rotation angle window or before entry into a subsequent first rotation angle window and one or more conditions are not fulfilled at this specific rotation angle or upon entry into the subsequent first rotation angle window, e.g. the rotation speed of the crank or eccentric drive falls below a specific rotation speed, it is advantageous that no further feed movement of the servo feed apparatus is performed until a new start request is made.

According to a third variant, it is preferable that after the press stop has been triggered and the feed movement profile has been completely followed, regardless of whether the rotation of the crank or eccentric drive comes to a standstill after the press stop has been triggered at a certain rotation angle before a subsequent first rotation angle window or before entering a subsequent first rotation angle window, no further feed movement of the servo feed apparatus takes place until a new start request is made.

Which of the three variants is preferred or less preferred depends heavily on the respective operating conditions and the product to be manufactured. For example, there are products that are less critical than others in terms of the tool immersion depth during production, so that even at low stroke speeds in braking mode or when the press is started up, usable products can still be produced. The first variant is particularly suitable for such products.

For products that are critical with regard to the tool immersion depth, the processes according to the second and third variants are more suitable than the first variant, wherein the second variant should be favored over the third in the event that multiple punching without feeding the material band could lead to a loss of quality.

A second aspect of the invention relates to a further method for operating a punch press with a press plunger driven by a crank or eccentric drive with a first part of a machining tool, wherein the press plunger operates in a machining zone of the punch press against a stationary clamping plate with an associated second part of the machining tool, and with a servo feed apparatus for intermittently feeding a band of material to be processed to the machining zone of the punch press.

As in the first method according to the invention, in this second method according to the invention, the press plunger is moved by the crank or eccentric drive between a first movement dead point during the intended punching operation of the punching press, in which the press plunger is at maximum distance from the clamping plate and the machining tool is maximally open, and a second movement dead point in which the press plunger is at minimal distance from the clamping plate and the machining tool is maximally closed. In typical punch presses, where the press plunger works from above against a fixed clamping plate, these movement dead points are the top dead point (also called “TDC”) and the bottom dead point (also called “BDC”) of the press plunger.

In this process, the material band is also advanced into the machining zone by a certain length by the servo feed apparatus in a first rotation angle window of the crank or eccentric drive around the first movement dead point and is machined with the machining tool in the feed pauses in a second rotation angle window of the crank or eccentric drive, which extends outside the first rotation angle window before and up to the second movement dead point.

As in the first method according to the invention, the feed movement of the servo feed apparatus also takes place in the intended punching operation of the punching press according to an electronically defined feed movement profile, which is electronically synchronized with the rotation of the crank or eccentric drive in the first rotation angle window.

According to the invention, in this second method according to the invention, when a press stop is triggered outside the first rotation angle window in the event that the rotation of the crank or eccentric drive does not come to a standstill latest at a certain rotation angle before the subsequent first rotation angle window or before entering the subsequent first rotation angle window after the triggering of the press stop, the synchronization of the feed movement profile with the rotation of the crank or eccentric drive is cancelled when the first rotation angle window is reached and the feed movement profile is then completely followed independently of the rotation of the crank or eccentric drive.

This second mode of operation according to the invention also reduces the maximum torque requirement of the feed axes for servo feeds operated angularly synchronously with the crank drive of the press plunger, so that smaller and therefore more cost-effective servo drives can be used or more load can be moved with a given servo drive.

It is preferable that the feed movement profile is followed at a rotation speed that corresponds to the rotation speed at which it was followed at the time the synchronization of the feed movement profile with the rotation of the crank or eccentric drive was cancelled. This ensures that the feed step is completed before the rotation of the crank or eccentric drive of the press can reach the second rotation angle window.

In the event that the rotation of the crank or eccentric drive does not come to a standstill at a certain rotation angle before the subsequent first rotation angle window or before entry into the subsequent first rotation angle window after the press stop has been triggered and the feed movement profile has subsequently been followed, it is preferred, according to a first variant of the second method according to the invention, that the feed movement profile is followed completely again after the subsequent first rotation angle window has been reached.

It is advantageous that, after reaching the subsequent first rotation angle window, the feed movement profile is again completely followed at a rotation speed that corresponds to the rotation speed at which it would be followed if it were synchronized with the rotation of the crank or eccentric drive when entering this subsequent first rotation angle window. This ensures that the feed step is completed before the rotation of the crank or eccentric drive of the press can reach the subsequent second rotation angle window.

According to a second variant of the second method according to the invention, in the event that the rotation of the crank or eccentric drive does not come to a standstill at a certain rotation angle before a subsequent first rotation angle window or before entry into a subsequent first rotation angle window after the press stop has been triggered and the feed movement profile has subsequently been followed, and one or more conditions are not fulfilled at this certain rotation angle or upon entry into the subsequent first rotation angle window, e.g. a rotation speed falls below a certain rotation speed of the crank or eccentric drive, it is advantageous that no further feed movement of the servo feed apparatus is performed until a new start request is made.

According to a third variant of the second method according to the invention, it is preferred that after the press stop is triggered and the feed movement profile is subsequently followed, regardless of whether the rotation of the crank or eccentric drive comes to a standstill at a certain rotation angle before a subsequent first rotation angle window or before entering a subsequent first rotation angle window, no further feed movement of the servo feed apparatus follows until a new start request is made.

Which of the three variants is more or less preferred also depends strongly on the respective operating conditions and the product to be manufactured in this second method according to the invention. For example, there are products that are less critical than others in terms of tool immersion depth during production, so that even at low stroke speeds in braking mode or when the punching press is started up, usable products are produced. The first variant is particularly suitable for such products. For products which are critical with regard to the tool immersion depth, the processes according to the second and third variants are better suited than the first variant, whereby the second variant should be favored over the third in the event that multiple punching without feeding the material band could lead to a loss of quality.

In further preferred embodiments of the first and second methods according to the invention, it is advantageous that, when the press is restarted to resume the intended punching operation after the press stop has been carried out, a feed movement of the servo feed apparatus takes place at the earliest in the next following first rotation angle window. This feed movement is preferably synchronized again with the rotation of the crank or eccentric drive.

According to an advantageous variant, the feed movement only takes place when one or more conditions are fulfilled at a certain rotation angle before a subsequent first rotation angle window or when entering the next first rotation angle window or a subsequent first rotation angle window, e.g. a certain rotation speed of the crank or eccentric drive is reached. This variant is particularly suitable for the manufacture of products that are critical in terms of tool immersion depth.

A third aspect of the invention relates to a punch press for operation according to one of the methods according to the first or second aspect of the invention. The punching press has a press plunger driven by a crank or eccentric drive with a first part of a machining tool which, during intended operation, works in a machining zone of the punching press against a fixed clamping plate with an associated second part of the machining tool. The punching press also has a servo feed apparatus for intermittently feeding a band of material to be processed to the machining zone of the punching press.

The punching press is designed in such a way that in the intended punching operation of the punching press, the press plunger is moved back and forth by the crank or eccentric drive between a first movement dead point, in which the press plunger is at maximum distance from the clamping plate and the machining tool is maximally open, and a second movement dead point, in which the press plunger is at minimum distance from the clamping plate and the machining tool is maximally closed.

In addition, the punching press is designed such that the material band is advanced into the machining zone by a certain length in a first rotation angle window of the crank or eccentric drive around the first movement dead point by the servo feed apparatus and is processed with the machining tool in the feed pauses in a second rotation angle window of the crank or eccentric drive, which extends outside the first rotation angle window before and up to the second movement dead point.

Furthermore, the punching press is designed in such a way that the feed movement of the servo feed apparatus takes place according to an electronically defined feed movement profile, which is electronically synchronized with the rotation of the crank or eccentric drive in the first rotation window.

According to the invention, the punching press comprises a control unit which, when a press stop is triggered in the first rotation angle window, cancels the synchronization of the feed movement profile with the rotation of the crank or eccentric drive and allows the feed movement profile to be followed to the end independently of the rotation of the crank or eccentric drive.

Alternatively or additionally, the control unit is designed in such a way that when a press stop is triggered outside the first rotation angle window in the event that the rotation of the crank or eccentric drive does not come to a standstill at a certain rotation angle before the subsequent first rotation angle window or before entering the subsequent first rotation angle window after the press stop has been triggered, it cancels the synchronization of the feed movement profile with the rotation of the crank or eccentric drive when the first rotation angle window is reached, and then allows the feed movement profile to follow completely independently of the rotation of the crank or eccentric drive.

### BRIEF DESCRIPTION OF THE DRAWINGS

Further preferred embodiments of the invention result from the dependent claims and from the following description with reference to the figures, which schematically illustrate different variants of the methods according to the invention.

FIGS. 1a, 1b, 3a, 3b, 9 and 10 each show schematic representations of the synchronisation situation between the electronically defined feed movement profile 5 and rotation of the crank shaft of the punching press 4 at the time of the press stop signal 6 and after the press has stopped, namely:

FIG. 1a at stop signal 6 within the feed phase 3 at a slow press stroke rate (100 strokes per minute);

FIG. 1b at stop signal 6 outside the feed phase 3 at a slow press stroke rate (100 strokes per minute);

FIG. 3a at stop signal 6 within the feed phase 3 at a fast press stroke rate (1000 strokes per minute);

FIG. 3b at stop signal 6 outside the feed phase 3 at a fast press stroke rate (1000 strokes per minute);

FIG. 9 at stop signal 6 within the feed phase 3 at fast press stroke rate (1000 strokes per minute) with premature feed stop;

FIG. 10 at stop signal 6 outside the feed phase 3 at a fast press stroke rate (1000 strokes per minute) with premature feed stop;

FIGS. 5, 6 and 13 each show schematic representations of the synchronization situation between the electronically defined feed movement profile 5 and the rotation of the crank shaft of the punching press 4 at the time of the press start signal 7 and after the press has started, namely:

FIG. 5 at start signal 7 within the feed phase 3 and acceleration to fast press stroke rate (1000 strokes per minute);

FIG. 6 at start signal 7 outside the feed phase 3 and acceleration to fast press stroke rate (1000 strokes per minute);

FIG. 13 at start signal 7 outside the feed phase 3 at a fast press stroke rate (1000 strokes per minute) with delayed feed start;

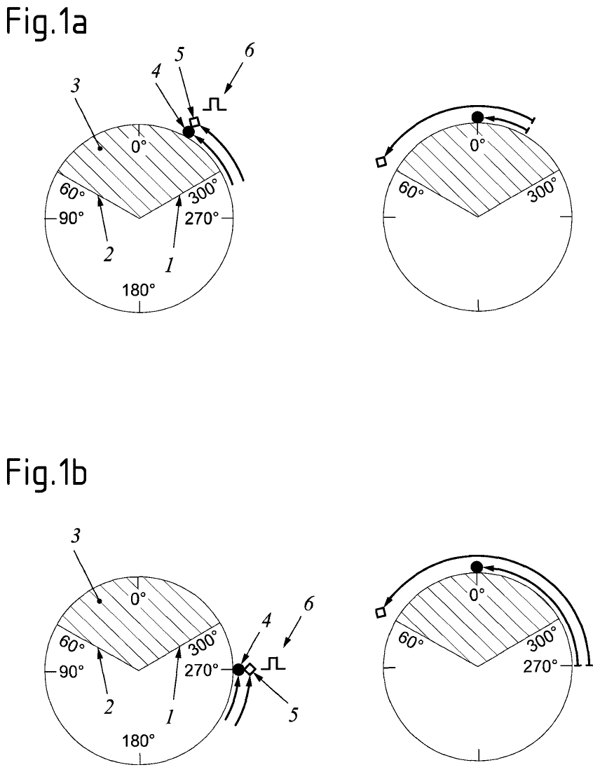

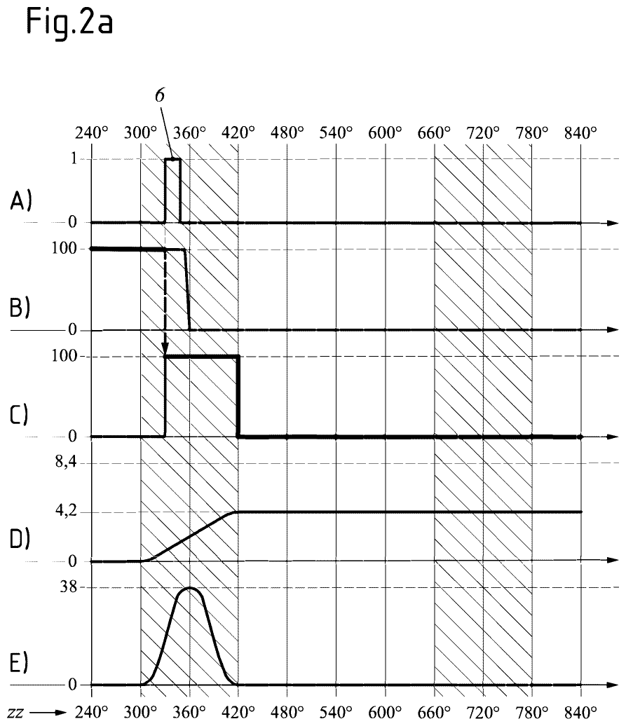

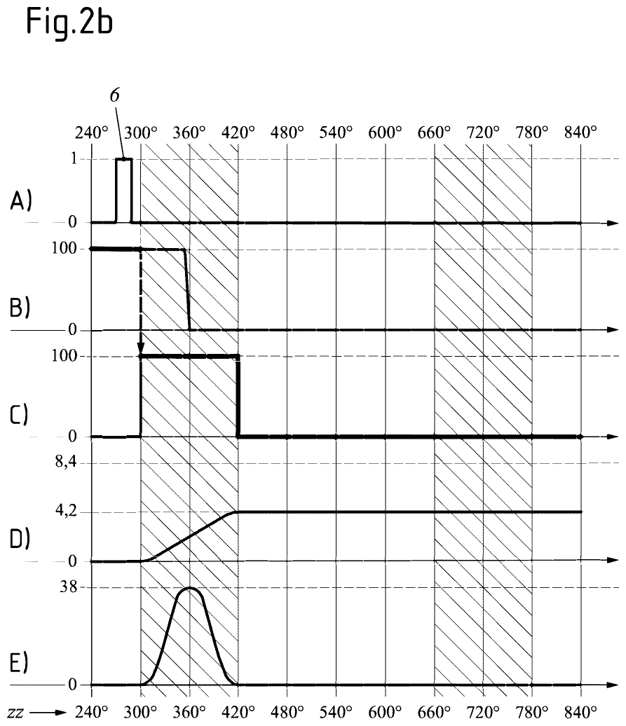

FIGS. 2a, 2b, 4a, 4b, 7, 8, 11, 12 and 14 show the progression of the following operating parameters over the rotation angle ZZ of the crank drive of the punching press for the situations shown in FIGS. 1a, 1b, 3a, 3b, 5, 6, 9, 10 and 13:

A=Stop or start signal
B=Rotation speed real guide value (1/min)
C=Rotation speed virtual guide value (1/min)
D=Actual feed position (°)
E=Actual feed rotation speed (°/s)

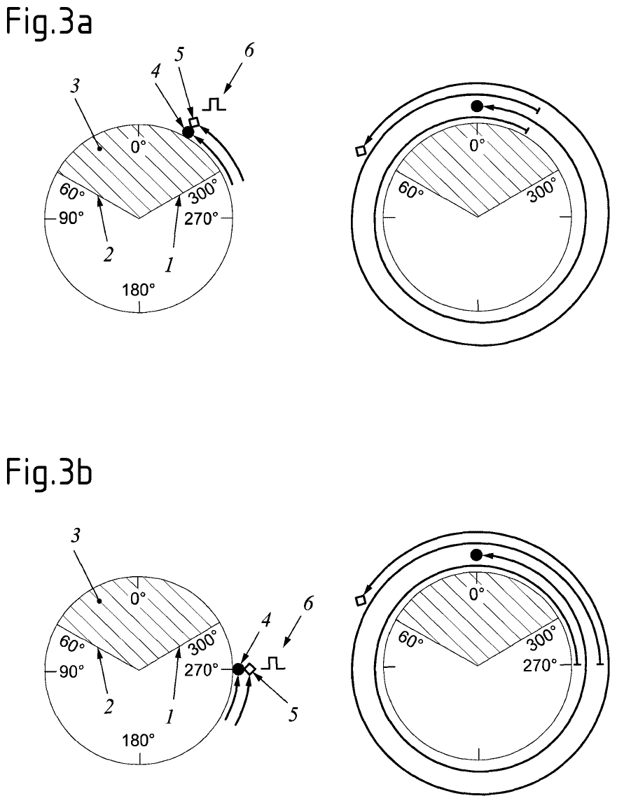

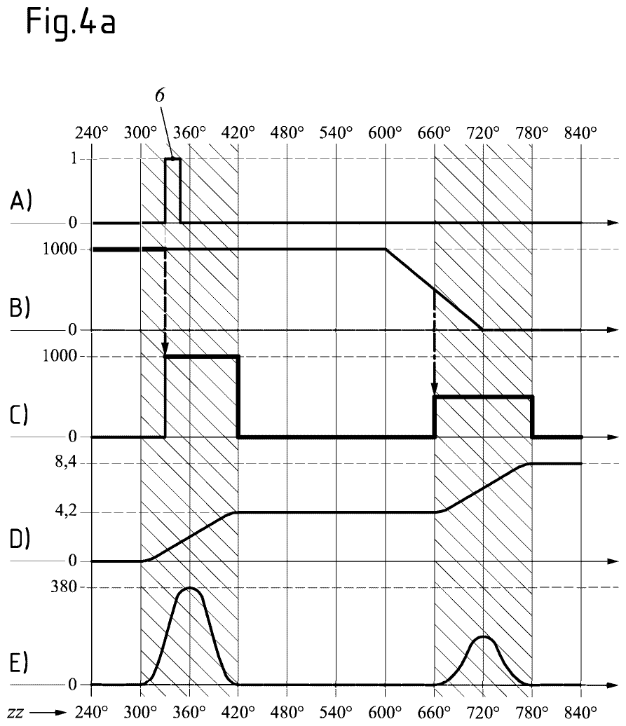

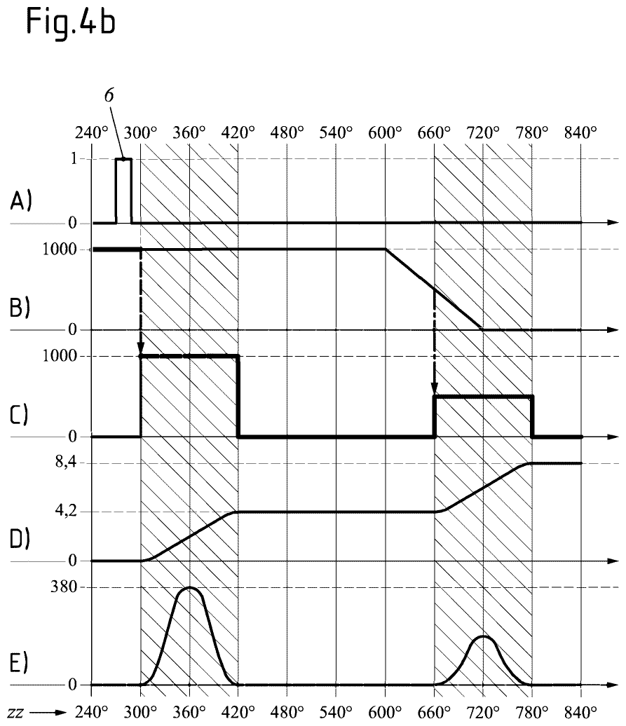

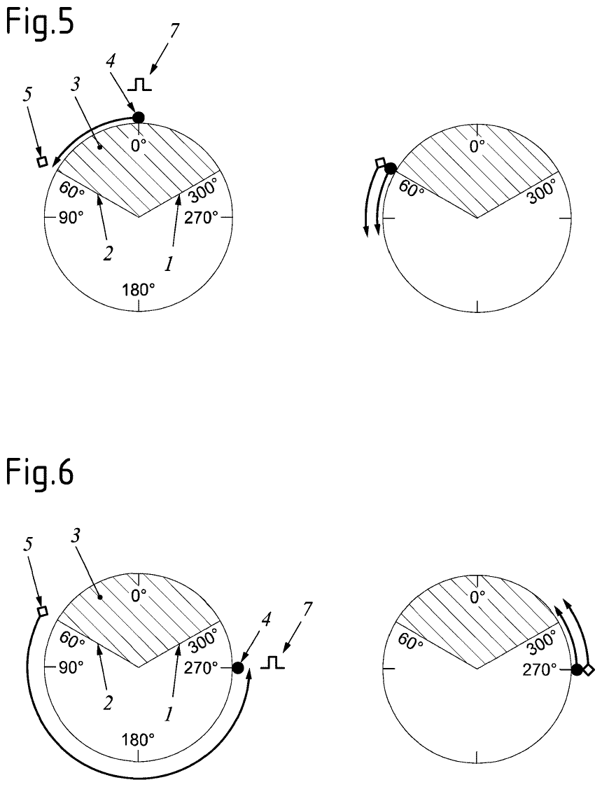

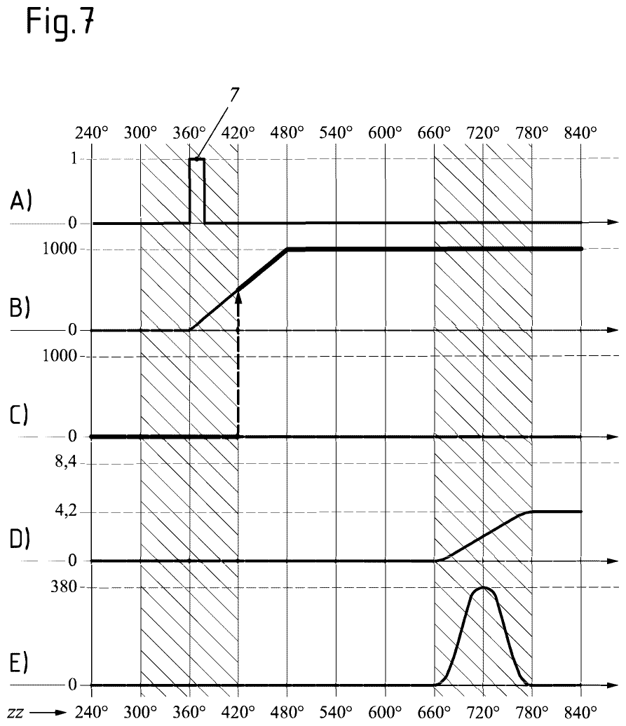

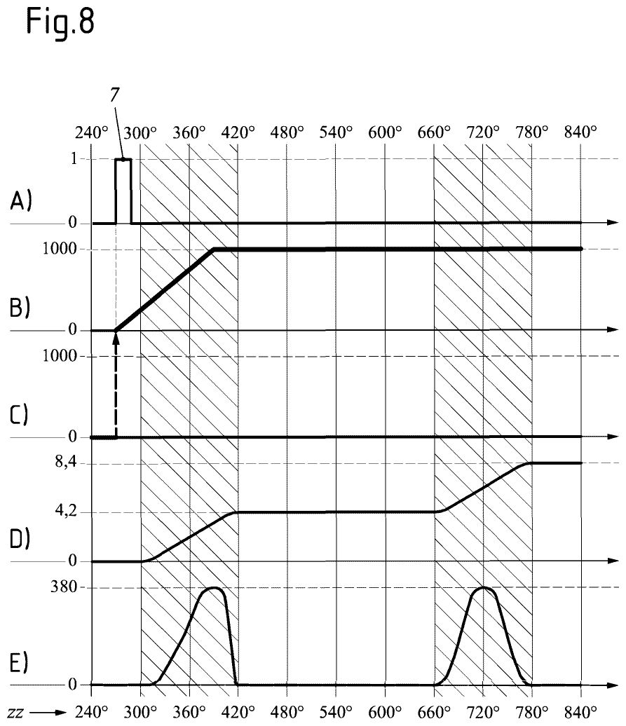

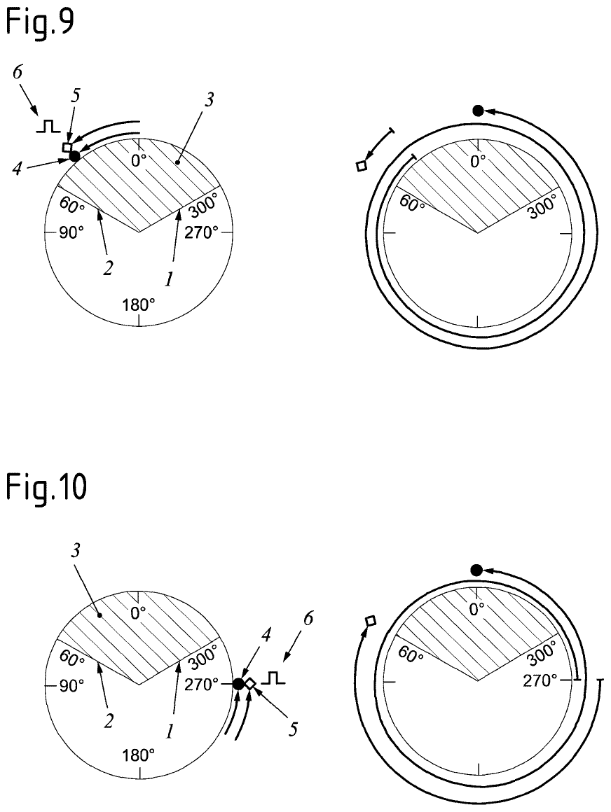

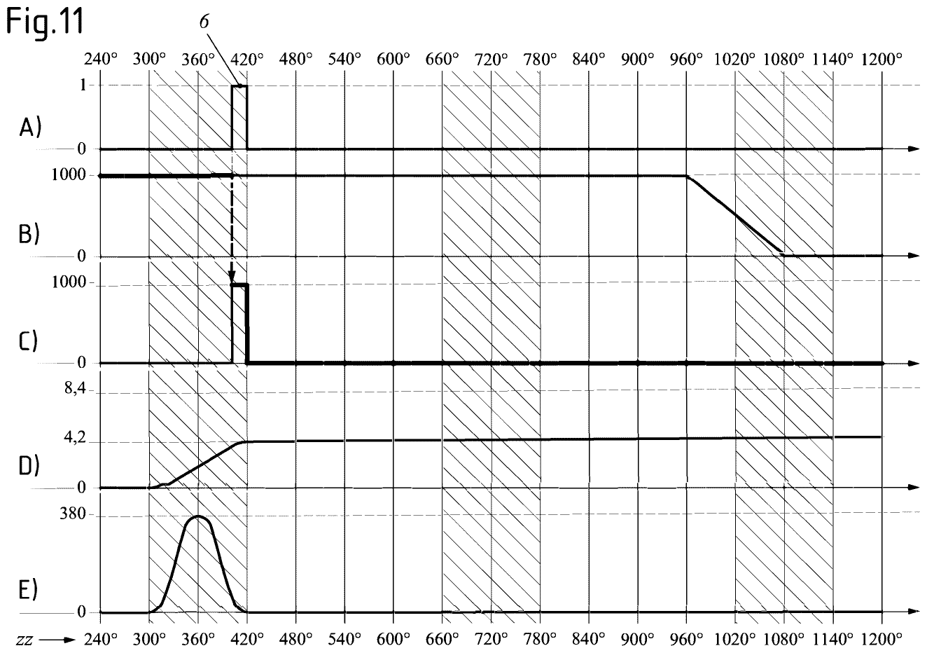

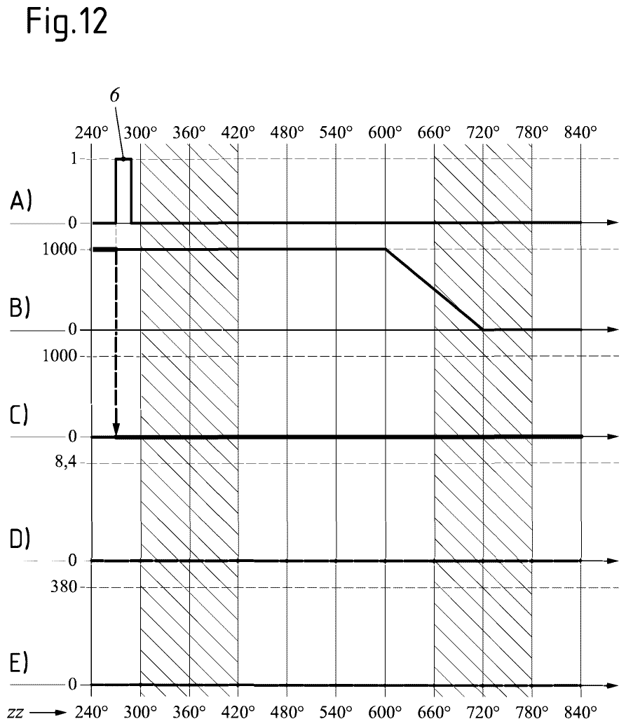

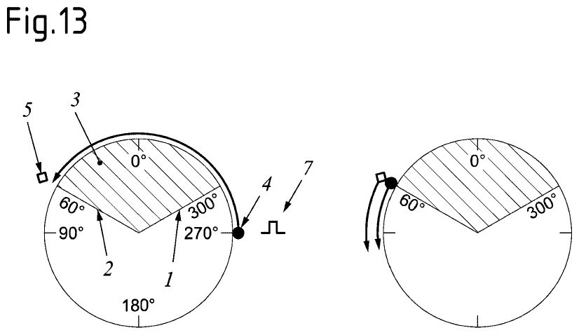

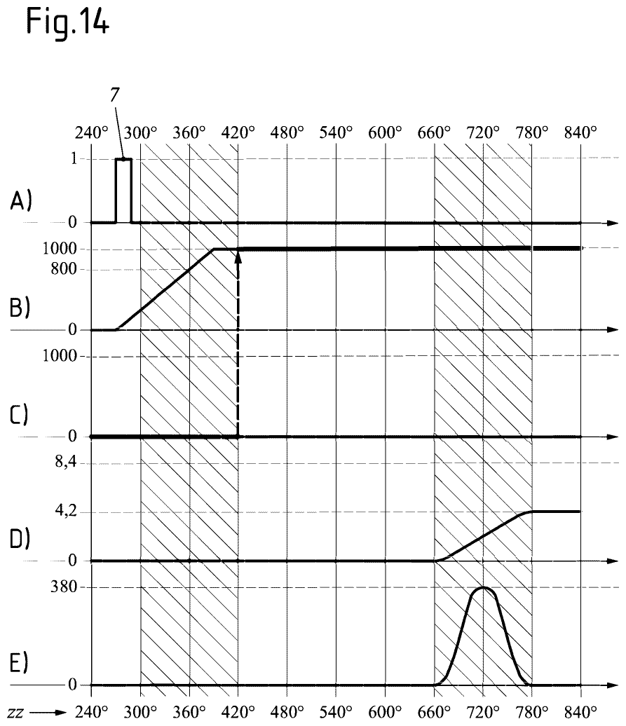

The figures belong together as follows:
FIG. 1a+FIG. 2a
FIG. 1b+FIG. 2b
FIG. 3a+FIG. 4a
FIG. 3b+FIG. 4b
FIG. 5+FIG. 7
FIG. 6+FIG. 8
FIG. 9+FIG. 11
FIG. 10+FIG. 12
FIG. 13+FIG. 14

### DETAILED DESCRIPTION

FIGS. 1a, 1b, 3a, 3b, 9 and 10 each show schematic representations of the synchronization situation between the electronically defined feed movement profile 5 and the rotation of the crank shaft of the punching press 4 at the time of the press stop signal 6 (left-hand representation) and after the press has stopped (right-hand representation). FIGS. 5, 6, 13 and 14 each show analogous schematic representations of the synchronization situation between the electronically defined feed movement profile 5 and the rotation of the crank shaft of the punching press 4 at the time of the press start signal 7 (left-hand representation) and after the press has started (right-hand representation).

One revolution (360°) of the crank shaft of the crank drive of the punch press is shown in the form of a circle, with the first movement dead point of the press plunger being indicated at the top as a 0° position and the second movement dead point at the bottom as a 180° position. The direction of rotation is counterclockwise. The feed phase 3 (the first rotation window according to the claims) is shown hatched and extends between a feed start angle 1 at 300° and a feed stop angle 2 at 60°. In all the examples shown here the braking process is initiated taking into account the braking distance (reaction time plus mechanical braking time) so that the press stops at top dead point, i.e. at 0°.

FIGS. 1a and 1b show a schematic representation of the synchronization situation between the electronically defined feed movement profile 5 and the rotation of the crank shaft 4 of the punching press at the time of the press stop signal 6 and after the press has stopped, once with a stop signal 6 within the feed phase 3 (FIG. 1a) and once with a stop signal 6 outside the feed phase 3 (FIG. 1b), in each case during operation with a slow press stroke rate (100 strokes per minute).

As can be seen from the left-hand illustration, which shows the synchronization situation between the electronically defined feed movement profile 5 and the rotation of the crank shaft of the punching press 4 at the time of the press stop signal, the feed profile 5 and the rotation of the crank shaft 4 run synchronously with each other up to the stop signal 6, in that the real rotation of the crank shaft 4 serves as the real guide value for the movement of the electronically defined feed profile 5 of the servo press feed.

As can be seen in the synopsis of FIG. 1a with FIG. 2a, which shows the course of various operating parameters over the rotation angle of the crank drive of the punching press for the situation shown, a stop request 6 is triggered at approx. 330° within the feed phase 3 (see curve A), whereby the clutch of the punching press to the press drive is opened and the brake is actuated. Immediately after the stop request 6 is detected, the synchronization between the electronically defined feed movement profile 5 and the rotation of the crank shaft of the punching press 4, which takes place via the rotation speed of the crank shaft of the punching press as a real guide value (see curve B)), is cancelled and replaced by a virtual guide value (see curve C)), which corresponds to the real guide value B) present at the time of the stop request 6 over the entire remaining feed phase 3. This change from the real guide value B) to the virtual guide value C) is indicated by a dashed arrow in FIG. 2a. As can be seen from the progress of the actual feed position (see curve D)) and actual feed rotation speed (see curve E)), the feed movement profile is completed with the virtual guide value C) as if there had been no stop request 6. The rotation speed of the virtual guide value is set to zero at the end 2 of feed phase 3 (at 420° or 60°) (see curve C)). As can be seen further, the rotation of the crank shaft 4 was stopped at the slow press stroke rate shown here within the feed phase at top dead point UT at 0° (see curve B)).

The situation with stop request 6 outside the feed phase 3 is shown analogously in FIGS. 1b and 2b. In the example shown, the stop request 6 is triggered at 270°, i.e. before the feed phase 3, and is also detected before the feed phase. As can be seen from curves A) and B), the crank shaft 4 rotates unbraked into the feed phase 3 and is only braked in the feed phase 3. In this case, the synchronization between the electronically defined feed movement profile 5 and the rotation of the crank shaft of the punching press 4 is cancelled due to the existing stop request 6 when entering the feed phase 3, which takes place via the rotation speed B) of the crank shaft of the punching press as a real guide value (see curve B)), and replaced by a virtual guide value C) (see curve C)), which corresponds to the real guide value B) present at the time of the stop request 6 over the entire remaining feed phase 3. This change from the real guide value B) to the virtual guide value C) is indicated in FIG. 2b by a dashed arrow. As can be seen from the curves of the actual position feed (see curve D)) and actual rotation speed feed (see curve E)), the feed movement profile is completed with the virtual guide value C) as if there had been no stop request 6. The rotation speed of the virtual guide value is set to zero at the end 2 of feed phase 3 (at 420° or 60°) (see curve C)). As can also be seen, the rotation of the crank shaft 4 was stopped at 0° or 360° during the top dead point UT of the feed phase with the slow pressing stroke rate shown here (see curve B)).

FIGS. 3a, 3b and 4a, 4b show illustrations like FIGS. 1a, 1b and 2a, 2b, but for operation at a fast press stroke rate (1000 strokes per minute).

As can be seen from a comparison of FIG. 2a or 2b and 4a or 4b, the most obvious difference to the operation of the press with a slow press stroke rate is that it is no longer possible to stop the press at top dead point within the first feed phase. The behaviour with regard to the cancellation of the synchronization between the electronically defined feed movement profile 5 and the rotation of the crank shaft of the punching press 4 and with regard to following to the end of the feed profile 5 by means of a virtual guide value C) is identical for the first feed phase 3 (300° to 420°) as with the slow press stroke rate.

In the present case, the crank shaft 4 rotates, both when stop request 6 is made within the feed phase 3 (FIGS. 3a and 4a) and when stop request 6 is made shortly before the feed phase (FIGS. 3b and 4b), unbraked through the first feed phase 3 and is braked at 6000 shortly before the second feed phase, so that it is stopped at top dead point at 7200 in the second feed phase.

As with the operation of the press with a slow press stroke rate as shown in FIGS. 2a and 2b, at the time of the stop request 6 in the feed phase 3 or at the time of the stop request 6 upon entry into the first feed phase 3, the synchronization between the electronically defined feed movement profile 5 and the rotation of the crank shaft of the punching press 4, which takes place via the rotation speed B) of the crank shaft of the punching press as a real guide value (see curve B)), is cancelled and replaced by a virtual guide value C) (see curve C)), which corresponds to the real guide value B) present at the time of the stop request 6 or the entry into the first feed phase 3 over the entire remaining feed phase 3. This change from the real guide value B) to the virtual guide value C) is indicated by a dashed arrow in FIGS. 4a and 4b. As can be seen from the curves of the actual feed position (see curve D)) and actual feed rotation speed (see curve E)), the feed movement profile in the first feed phase 3 is completed with this first virtual guide value C) as if there had been no stop request 6. The rotation speed of the virtual guide value is set to zero at the end 2 of the first feed phase 3 (at 420° or 60°) (see curve C)) and set to the current rotation speed B) of the crank shaft of the punching press 4 at the start of the subsequent second feed phase 3 (see dotted arrow).

As can be seen from the curves of the actual feed position (see curve D)) and actual feed rotation speed (see curve E)), the feed movement profile is completed with the second virtual guide value C) and the rotation of the crank shaft 4 in the second feed phase 3 stops at top dead point at 720° or 0° (see curve B)). As can be seen, at the second virtual guide value C), the maximum actual rotation speed E) of the feed achieved is only about half as high as in the first feed phase 3. This rotation speed of the second virtual guide value is set to zero at the end 2 of the second feed phase 3 (at 780° or 60°) (see curve C)).

FIG. 5 shows a schematic representation of the synchronization situation between the electronically defined feed movement profile 5 and the rotation of the crank shaft 4 of the punch press at the time of the press start signal 7 and after the press has started with a start signal 7 within the feed phase 3 and an acceleration of the punch press to a fast press stroke rate (1000 strokes per minute).

As can be seen from the left-hand representation, which shows the synchronization situation between the electronically defined feed movement profile 5 and the rotation of the crank shaft of the punching press 4 at the time of the press start signal 7, the press is at a standstill at 0° when the start request 7 occurs, i.e. in the middle of the last feed phase 3, while the feed of the punching press has completed the last feed phase and is at 60° at the end 2 of the last feed phase 3. As soon as the start request 7 is recognized, the brake of the punching press is opened and the clutch is closed, and the crank shaft of the press begins to rotate and accelerates to the desired speed.

As can be seen from the right-hand representation in FIG. 5 in conjunction with FIG. 7, which shows the progression of various operating parameters over the rotation angle of the crank drive of the punching press for the situation shown, the synchronization between the electronically defined feed movement profile 5 and the rotation of the crank shaft of the punching press 4 takes place as soon as the rotation of the crank shaft 4 has reached the end 2 of the feed phase at 60° or 420° (see curves B) and C) in FIG. 7). From this point onwards, the feed profile 5 and the rotation of the crank shaft 4 run synchronously with each other, in that the real rotation of the crank shaft 4 then serves as the real guide value B) for the following of the electronically defined feed movement profile 5 of the electronically defined feed movement profile 5 of the servo press feed. Accordingly, in the subsequent feed phase, the electronically defined feed movement profile 5 of the servo press feed is followed synchronously to the real rotation of the crank shaft 4. The corresponding curves of the actual position of the feed and the actual rotation speed of the feed are shown in curves D) and E).

FIG. 6 shows a schematic representation of the synchronization situation between the electronically defined feed movement profile 5 and the rotation of the crank shaft 4 of the punching press at the time of the press start signal 7 and after the press has started with a start signal 7 before the feed phase 3 and acceleration of the punching press to a fast press stroke rate (1000 strokes per minute).

As can be seen from the illustration on the left, which shows the synchronization situation between the electronically defined feed movement profile 5 and the rotation of the crank shaft of the punching press 4 at the time of the press start signal 7, the press in the present case is at a standstill at 270° when the start request 7 occurs, i.e. 30° before the upcoming feed phase 3, while the feed of the punching press has completed the last feed phase and is at 60° at the end 2 of the last feed phase 3. As soon as the start request 7 is recognized, the brake of the punching press is opened and the clutch is closed, and the crank shaft of the press begins to rotate and accelerates to the desired speed.

As can be seen from the illustration on the right in conjunction with FIG. 8, which shows the course of various operating parameters over the rotation angle of the crank drive of the punching press for the situation shown, the synchronization between the electronically defined feed movement profile 5 and the rotation of the crank shaft of the punching press 4 takes place as soon as the start signal 7 is detected, i.e. from the start of movement of the cranks shaft. For this purpose, the system switches from the virtual guide value C) to the real guide value B). From this point onwards, the feed profile 5 and the rotation of the crank shaft 4 run synchronously with each other in that the real rotation of the crank shaft 4 serves as the real guide value B) for running the electronically defined feed movement profile 5 of the servo press feed. Accordingly, in the subsequent feed phase, the electronically defined feed movement profile 5 of the servo press feed is also followed synchronously to the real rotation of the crank shaft 4. The corresponding curves of the actual position of the feed and the actual rotation speed of the feed are shown in curves D) and E).

FIGS. 9 and 11 show illustrations like FIGS. 3a and 4a, but with a stop request 6 at 40° or 400°, i.e. towards the end of the feed phase 3, and also for an operating variant in which an early feed stop is desired, i.e. no more feed movement is to take place after execution of the feed movement that has started until the next start request.

Accordingly, apart from a slightly different angular position of the stop signal 6 up to the start 1 of the second feed phase 3, the curves in FIG. 11 are practically identical to those in FIG. 4a, which is why reference can be made here to the explanations relating to FIGS. 3a and 4a. Since, in contrast to the example in FIGS. 3a and 4a, there is no further feed movement after completion of the first feed phase 3, the curves C), D) and E) no longer change after completion of the first feed phase 3.

FIGS. 10 and 12 show representations like FIGS. 3b and 4b, but for an operating variant in which an immediate feed stop is desired, i.e. no more feed movement is to take place until the next start request.

As can be seen, immediately after the stop request 6 is detected, the synchronization between the electronically defined feed movement profile 5 and the rotation of the crank shaft of the punching press 4, which takes place via the rotation speed of the crank shaft of the punching press as the real guide value (see curve B)), is cancelled and replaced by the virtual guide value (see curve C)), which corresponds to a rotation speed of zero. This change from the real guide value B) to the virtual guide value C) is indicated in FIG. 12 by a dashed arrow. As can be seen from the curves of the actual feed position (see curve D)) and actual feed rotation speed (see curve E)), there is no feed movement when entering the feed phase 3. The crank shaft 4 rotates unbraked through the first feed phase 3 and is braked at 600° shortly before the second feed phase, so that it is stopped at top dead point at 720° in the second feed phase.

FIGS. 13 and 14 show illustrations like FIGS. 6 and 8, but for an operating variant in which a delayed advance start is desired, e.g. only after a certain minimum rotation speed B) of the crank shaft has been reached. In this example, the required minimum rotation speed of the crank shaft is 800 revolutions per minute. This minimum rotation speed is reached in the advance feed phase 3, which is why the synchronization between the electronically defined feed movement profile 5 and the rotation of the crank shaft of the punching press 4, which takes place via the rotation speed of the crank shaft of the punching press as the real guide value for the movement of the feed profile 5 (see curve B)), is only carried out after the end of the advance feed phase and a feed movement only follows in the subsequent second feed phase. In cases in which the minimum rotation speed is reached outside of the feed phase, synchronization between the electronically defined feed movement profile 5 and the rotation of the crank shaft 4 takes place as soon as the minimum rotation speed is reached.

While preferred embodiments of the invention are described in the present application, it should be clearly noted that the invention is not limited thereto and may be practiced in other ways within the scope of the claims now following.

What is claimed is:

1. A method for operating a punching press with a press plunger driven by a crank or eccentric drive with a first part of a machining tool, wherein the press plunger operates in a machining zone of the punching press against a stationary clamping plate with an associated second part of the machining tool, and with a servo feed apparatus for intermittently feeding a band of material to be machined to the machining zone of the punching press,
wherein in the intended punching operation of the punching press
a) the press plunger is moved back and forth by the crank or eccentric drive between a first movement dead point (0°), in which the press plunger is at maximum distance from the clamping plate and the machining tool is at maximum opening, and a second movement dead point (180°), in which the press plunger is at minimum distance from the clamping plate and the machining tool is at maximum closing,
b) the material band is advanced in a first rotation angle window of the crank or eccentric drive around the first movement dead point (0°) by the servo feed apparatus by a certain length into the machining zone and is machined with the machining tool in the feed pauses in a second rotation angle window of the crank or eccentric drive, which extends outside the first rotation angle window before and up to the second movement dead point (180°),
c) the feed movement of the servo feed apparatus takes place according to an electronically defined feed movement profile, which is followed electronically synchronized with the rotation of the crank or eccentric drive in the first rotation angle window,
wherein when a press stop is triggered in the first rotation angle window, the synchronization of the feed movement profile with the rotation of the crank or eccentric drive is cancelled and the feed movement profile is followed to the end independently of the rotation of the crank or eccentric drive.

2. The method according to claim 1, wherein the feed movement profile is followed to the end at a rotation speed which corresponds to the rotation speed at which it was followed at the time of triggering the press stop or at the time of cancelling the synchronization of the feed movement profile with the rotation of the crank or eccentric drive.

3. The method according to claim 1, wherein, in the event that the rotation of the crank or eccentric drive does not come to a standstill at a certain rotation angle before a subsequent first rotation angle window or before entry into a subsequent first rotation angle window after the press stop has been triggered, the feed movement profile is again fully continuously followed after reaching the subsequent first rotation angle window.

4. The method according to claim 3, wherein the feed movement profile, after reaching the subsequent first rotation angle window, is again followed completely at a rotation speed which corresponds to the rotation speed at which it would be followed in the case of a synchronization with the rotation of the crank or eccentric drive when entering this subsequent first rotation angle window.

5. The method according to claim 1, wherein, in the event that after triggering the press stop the rotation of the crank or eccentric drive does not come to a standstill at a specific rotation angle before a subsequent first rotation angle window or before entry into a subsequent first rotation angle window and one or more conditions are not fulfilled at this specific rotation angle or upon entry into the subsequent first rotation angle window, in particular the rotational rotation speed falls below a certain rotational rotation speed of the crank or eccentric drive, no further feed movement of the servo feed apparatus takes place until a new start request is made.

6. The method according to claim 1, wherein after the triggering of the press stop and the complete following of the feed movement profile, irrespective of whether the rotation of the crank or eccentric drive comes to a standstill after the triggering of the press stop at a certain rotation angle before a subsequent first rotation angle window or before entry into a subsequent first rotation angle window, no further feed movement of the servo feed apparatus takes place until a new start request.

7. A method for operating a punching press with a press plunger driven by a crank or eccentric drive with a first part of a machining tool, wherein the press plunger works in a machining zone of the punching press against a stationary clamping plate with an associated second part of the machining tool, and with a servo feed apparatus for intermittently feeding a band of material to be machined to the machining zone of the punching press,
wherein in the intended punching operation of the punching press
a) the press plunger is moved back and forth by the crank or eccentric drive between a first movement dead point (0°), in which the press plunger is at maximum distance from the clamping plate and the machining tool is at maximum opening, and a second movement dead point (180°), in which the press plunger is at minimum distance from the clamping plate and the machining tool is at maximum closing,
b) the material band is advanced into the machining zone by a certain length in a first rotation angle window of the crank or eccentric drive around the first movement dead point (0°) by the servo feed apparatus and is machined with the machining tool in the feed pauses in a second rotation angle window of the crank or eccentric drive, which extends outside the first rotation window before and up to the second movement dead point (180°),
c) the feed movement of the servo feed apparatus takes place according to an electronically defined feed movement profile, which is electronically synchronized to the rotation of the crank or eccentric drive in the first rotation angle window,
wherein when a press stop is triggered outside the first rotation angle window, in the event that the rotation of the crank or eccentric drive after the triggering of the press stop does not come to a standstill latest at a certain rotation angle before the subsequent first rotation angle window or before entry into the subsequent first rotation angle window, the synchronization of the feed movement profile with the rotation of the crank or eccentric drive is cancelled when the first rotation angle window is reached and the feed movement profile is then followed independently of the rotation of the crank or eccentric drive.

8. The method according to claim 7, wherein the feed movement profile is followed at a rotation speed which corresponds to the rotation speed at which it was followed at the time of cancelling the synchronization of the feed movement profile with the rotation of the crank or eccentric drive.

9. The method according to claim 7, wherein in the event that the rotation of the crank or eccentric drive does not come to a standstill at a certain rotation angle before the subsequent first rotation angle window or before entry into the subsequent first rotation angle window after the triggering of the press stop and the subsequent following of the feed movement profile, the feed movement profile is again fully continuously followed after reaching the following first rotation angle window.

10. The method according to claim 9, wherein the feed movement profile, after reaching the subsequent first rotation angle window, is again completely followed at a rotation speed which corresponds to the rotation speed at which it would be followed when synchronized with the rotation of the crank or eccentric drive upon entry into this subsequent first rotation angle window.

11. The method according to claim 7, wherein in the case that after the triggering of the press stop and the subsequent following of the feed movement profile the rotation of the crank or eccentric drive does not stop at a certain rotation angle before a subsequent first rotation angle window or before entry into a subsequent first rotation angle window and one or more conditions are not fulfilled at this particular rotation angle or upon entry into the subsequent first rotation angle window, in particular the rotational rotation speed falls short of a certain rotational rotation speed (B) of the crank or eccentric drive, no further feed movement of the servo feed apparatus takes place until a first new start request.

12. The method according to claim 7, wherein after the triggering of the press stop and the subsequent following of the feed movement profile independently whether the rotation of the crank or external drive comes to a standstill at a certain rotation angle before a subsequent first rotation angle window or before entry into a subsequent first rotation angle window, no further feed movement of the servo feed apparatus takes place until a new start request.

13. A method for operating a punching press with a press plunger driven by a crank or eccentric drive with a first part of a machining tool, wherein the press plunger works in a machining zone of the punching press against a stationary clamping plate with an associated second part of the machining tool, and with a servo feed apparatus for intermittently feeding a band of material to be machined to the machining zone of the punching press,
wherein in the intended punching operation of the punching press
a) the press plunger is moved back and forth by the crank or eccentric drive between a first movement dead point (0°), in which the press plunger is at maximum distance from the clamping plate and the machining tool is at maximum opening, and a second movement dead point (180°), in which the press plunger is at minimum distance from the clamping plate and the machining tool is at maximum closing,
b) the material band is advanced into the machining zone by a certain length in a first rotation angle window of the crank or eccentric drive around the first movement dead point (0°) by the servo feed apparatus and is machined with the machining tool in the feed pauses in a second rotation angle window of the crank or eccentric drive, which extends outside the first rotation window before and up to the second movement dead point (180°),
c) the feed movement of the servo feed apparatus takes place according to an electronically defined feed movement profile, which is electronically synchronized to the rotation of the crank or eccentric drive in the first rotation angle window,
wherein when a press stop is triggered outside the first rotation angle window, the synchronization of the feed movement profile with the rotation of the crank or eccentric drive is cancelled and no further feed movement of the servo feed apparatus takes place until a new start request is made.

14. The method according to claim 1, wherein, when the press is restarted in order to resume the intended punching operation after the press stop has been carried out, a feed movement of the servo feed apparatus, in particular synchronized with the rotation of the crank or eccentric drive, takes place at the earliest in the next following first rotation angle window.

15. The method according to claim 13, wherein the feed movement only takes place when one or more conditions are fulfilled at a specific rotation angle before a subsequent first rotation angle window or when entering the next subsequent first rotation angle window or a subsequent first rotation angle window, in particular a specific rotation speed (B) of the crank or eccentric drive is reached.

16. A punching press for operation according to claim 1, with a press plunger driven by a crank or eccentric drive with a first part of a machining tool, the press plunger operating in a machining zone of the punching press against a stationary clamping plate with an associated second part of the machining tool, and with a servo feed apparatus for intermittently feeding a band of material to be machined to the machining zone of the punching press.
whereby in the intended punching operation of the punching press
a) the press plunger is moved back and forth by the crank or eccentric drive between a first movement dead point (0°), in which the press plunger is at maximum distance from the clamping plate and the machining tool is at maximum opening, and a second movement dead point (180°), in which the press plunger is at minimum distance from the clamping plate and the machining tool is at maximum closing,
b) the material band is advanced into the machining zone by a certain length in a first rotation angle window of the crank or eccentric drive around the first movement dead point (0°) by the servo feed apparatus and is machined with the machining tool in the feed pauses in a second rotation angle window of the crank or eccentric drive, which extends outside the first rotation window before and up to the second movement dead point (180°),
c) the feed movement of the servo feed apparatus takes place according to an electronically defined feed movement profile, which is electronically synchronized to the rotation of the crank or eccentric drive in the first rotation angle window,
wherein the punching press comprises a control unit, which, when a press stop is triggered in the first rotation angle window, cancels the synchronization of the feed movement profile with the rotation of the crank or eccentric drive and allows the feed movement profile to travel to the end independently of the rotation of the crank or eccentric drive,
and/or
which, when a press stop is triggered outside the first rotation angle window, in the event that the rotation of the crank or eccentric drive after the triggering of the press stop does not come to a standstill at a specific rotation angle before the subsequent first rotation angle window or before entry into the subsequent first rotation angle window, cancels the synchronization of the feed movement profile with the rotation of the crank or eccentric drive when the first rotation angle window is reached and then allows the feed movement profile to move independently of the rotation of the crank or eccentric drive.
